(19) United States
(12) Patent Application Publication
(10) Pub. No.: US 2007/0291513 A1
(43) Pub. Date: Dec. 20, 2007

(54) Backlight module structured for absorbing electromagnetic radiation and liquid crystal display device using same

(75) Inventors: Wei Zhou, Shenzhen (CN); Qian Kang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/820,084

(22) Filed: Jun. 18, 2007

(30) Foreign Application Priority Data
Jun. 16, 2006 (TW) 95121698

(51) Int. Cl. F21V 7/04

(52) U.S. Cl. 362/633

(57) ABSTRACT

An exemplary backlight module (200) includes a light source (250), and a frame (260) containing the light source therein. The frame includes an absorbing material for absorbing electromagnetic radiation generated by the light source. The frame of the backlight module installed in an LCD device (20) contains absorbing material therein, which helps to shield an LCD panel (290) of the LCD device from any electromagnetic interference may be generated by the backlight module including the light source.

### FIELD OF THE INVENTION

The present invention relates to light sources typically used for liquid crystal display (LCD) devices; and more particularly to a backlight module capable of absorbing electromagnetic radiation, and an LCD device incorporating the backlight module.

### BACKGROUND

Liquid crystal displays are commonly used as display devices for compact electronic apparatuses, because they not only provide good quality images with little power but also are very thin. The liquid crystal in a liquid crystal display does not emit any light itself. The liquid crystal has to be lighted by a light source so as to clearly and sharply display text and images. Thus, a backlight module is generally needed for a liquid crystal display.

FIG. 6 is an exploded view of a conventional LCD device. The LCD device 10 includes an LCD panel (not shown) and a backlight module 100 for illuminating the LCD panel. The backlight module 100 includes an upper brightness enhancement film 110, a bottom brightness enhancement film 120, a diffusion sheet 130, a light guide plate 140, a plurality of light sources 150, a frame 160 for receiving the light guide plate 140 and the light sources 150, and a reflective plate 170. The light guide plate 140 includes a light incident surface 141, a light output surface 142 adjoining the light incident surface 141, and a bottom surface 143 opposite to the light output surface 142. After assembly, the upper brightness enhancement film 110, the bottom brightness enhancement film 120, and the diffusion sheet 130 are arranged on the light output surface 142 of the light guide plate 140 in that order from top to bottom. The light sources 150 are arranged adjacent to the light incident surface 141, and the reflective plate 170 is arranged adjacent to the bottom surface 143.

The light sources 150 may be a plurality of light emitting diodes (LEDs). The light guide plate 140 can convert light beams emitted by the light sources 150 into a planar light source, for illuminating the LCD panel which is installed above the backlight module 100.

In operation, the light sources 150 and other electronic elements of the LCD device irradiate a large amount unwanted electromagnetic waves. The electromagnetic waves are liable to interfere with electronic elements of the LCD device incorporating the backlight module 100. That is, the LCD device may be subjected to electromagnetic interference (EMI). The EMI may cause a display screen of the LCD panel to flicker.

Accordingly, what is needed is a backlight module and an LCD device that can overcome the above-described deficiencies.

### SUMMARY

An exemplary backlight module includes a light source, and a frame containing the light source therein. The frame includes an absorbing material for absorbing electromagnetic radiation generated by the light source.

An exemplary LCD device includes an LCD panel, and a backlight module for illuminating the LCD panel. The backlight module includes a light source, and a frame containing the light source therein. The frame includes an absorbing material for absorbing electromagnetic radiation generated by the light source.

Other novel features and advantages will become apparent from the following detailed description of preferred embodiments when taken in conjunction with the accompanying drawings. In the drawings, all the views are schematic.

### BRIEF DESCRIPTION OF THE DRAWINGS

FIG. 1 is an exploded, isometric view of an LCD device according to a first embodiment of the present invention.

FIG. 2 is a flow chart of a method for manufacturing a frame of a backlight module of the LCD device of FIG. 1.

FIG. 3 is an isometric view of a frame for an LCD device according to a second embodiment of the present invention.

FIG. 4 is an enlarged, cross-sectional view taken along line IV-IV of FIG. 3.

FIG. 5 is a flow chart of a method for manufacturing the frame of FIG. 3.

FIG. 6 is an exploded, isometric view of a conventional LCD device.

### DETAILED DESCRIPTION OF PREFERRED EMBODIMENTS

Reference will now be made to the drawings to describe preferred and exemplary embodiments of the present invention in detail.

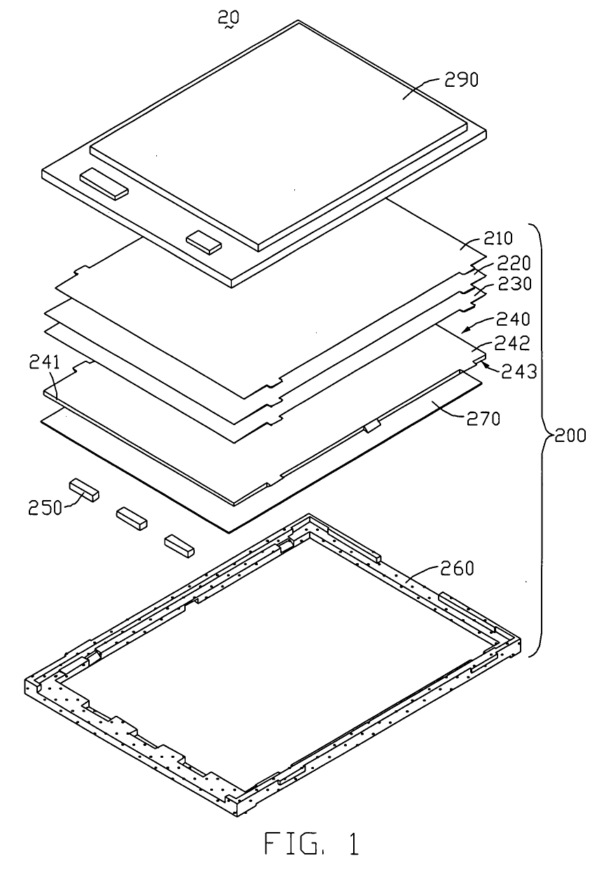

Referring to FIG. 1, an exploded, isometric view of an LCD device 20 according to a first embodiment of the present invention is shown. The LCD device 20 includes an LCD panel 290, and a backlight module 200 arranged under the LCD panel 290. The backlight module 200 provides light beams to illuminate the LCD panel 290, so that the LCD panel 290 can display images.

The backlight module 200 includes an upper brightness enhancement film 210, a bottom brightness enhancement film 220, a diffusion sheet 230, a light guide plate 240, a plurality of light sources 250, a frame 260, and a reflective plate 270. The light guide plate 240 includes a light incident surface 241, a light output surface 242 adjoining the light incident surface 241, and a bottom surface 243 opposite to the light output surface 242.

After assembly, the frame 260 receives the light guide plate 240 and the light sources 250 therein. The upper brightness enhancement film 210, the bottom brightness enhancement film 220, and the diffusion sheet 230 are arranged on the light output surface 242 of the light guide plate 240 in that order from top to bottom. The light sources 250 are arranged adjacent to the light incident surface 241, and the reflective plate 270 is arranged adjacent to the bottom surface 243. The frame 260 is a plastic frame 260, and carbon fiber is dispersed in the frame 260.

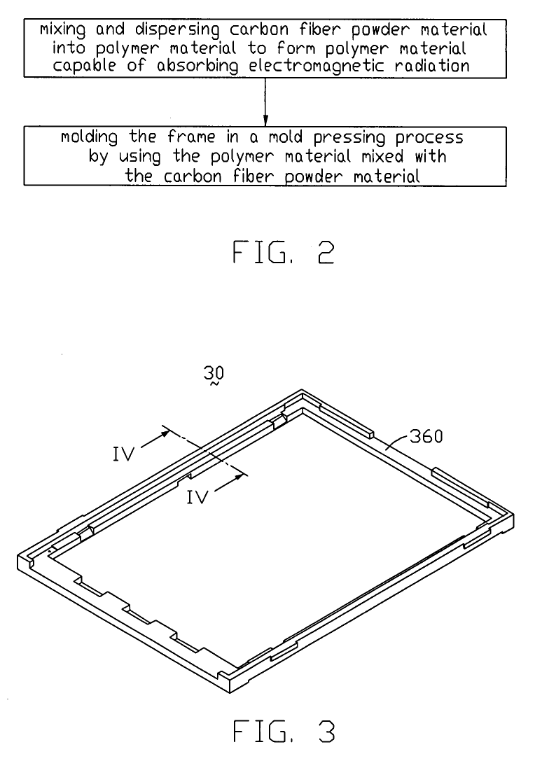

Referring to FIG. 2, a flow chart of a method for manufacturing the frame 260 is shown. The method includes the steps of: mixing and dispersing carbon fiber powder material into polymer material to form polymer material capable of absorbing electromagnetic radiation; and molding the frame 260 in a mold pressing process by using the polymer material mixed with the carbon fiber powder material.

Unlike a conventional frame installed in a backlight module and an LCD, the present frame 260 installed in the LCD device 20 contains carbon fiber. Therefore the frame 260 helps shield the LCD panel 290 from any electromagnetic interference that may be generated by the backlight module 200, such as electromagnetic interference that originates from the light sources 250. In addition, because carbon fiber is an electrically conductive material, the frame 260 with the carbon fiber can avoid ESD (electro static discharge). That is, the frame 260 can function similar to a metal shielding cover. Furthermore, the carbon fiber helps ensure that the frame 260 has good heat sinking capability. As a result, the upper brightness enhancement film 210, the bottom brightness enhancement film 220, and the diffusion sheet 230 avoid warping due to heat generated by the light sources 250.

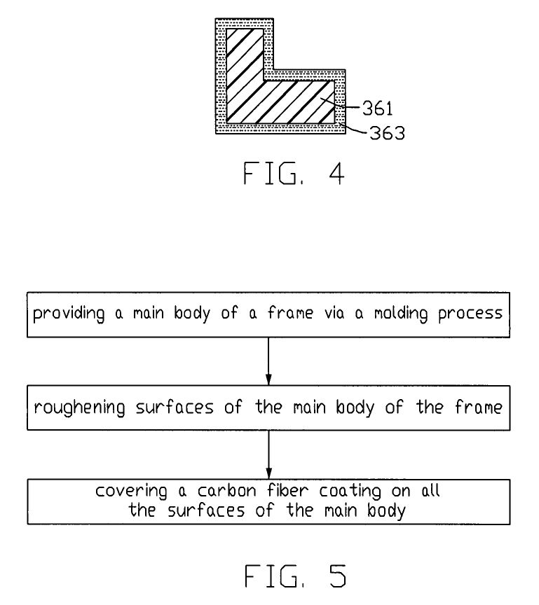

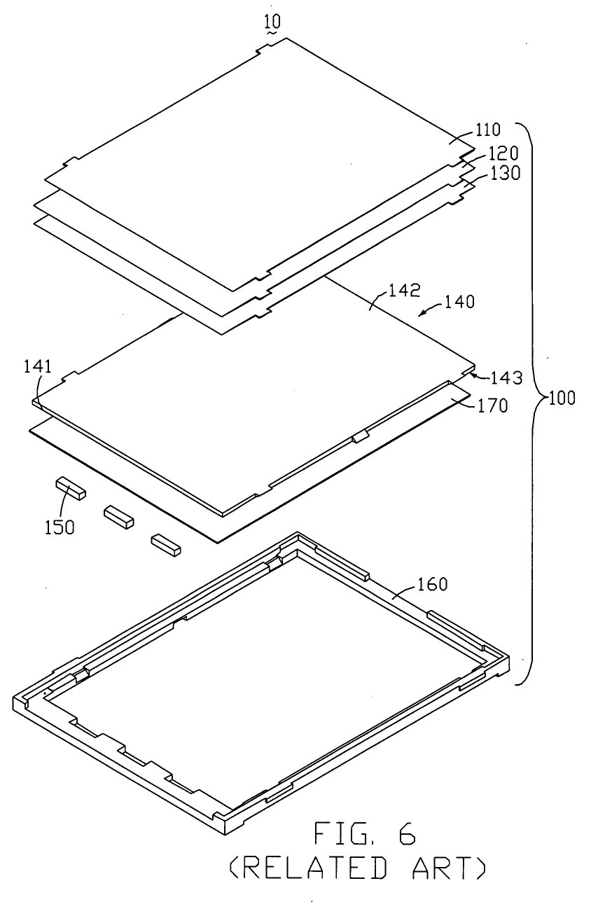

Referring to FIGS. 3-4, aspects of a frame of an LCD device 30 according to a second embodiment of the present invention are shown. The LCD device 30 has a structure similar to that of the LCD device 20. In particular, the LCD device 30 includes a frame 360 for containing optical elements, such as a plurality of light sources (not shown), and a light guide plate (not shown). The frame 360 is made substantially of polymer material, and is manufactured by a molding process. In particular, the frame 360 includes a main body 361 made of polymer material, and a carbon fiber coating 363 covering by the main body 361. The carbon fiber coating 363 is for absorbing electromagnetic radiation. In the illustrated embodiment, the carbon fiber coating 363 completely covers all surfaces of the main body 361.

Referring to FIG. 5, a flow chart of a method for manufacturing the frame 360 is shown. The method includes the steps of: providing the main body 361 of the frame 360 via a molding process; roughening surfaces of the main body 361 of the frame 360; and covering the carbon fiber coating 363 on all the surfaces of the main body 361.

When the frame 360 with the carbon fiber coating 363 is installed in the LCD device 30, the frame 360 helps to shield the LCD panel 290 from any electromagnetic interference that may be generated by the corresponding backlight module (not shown), such as electromagnetic interference that originates from the light sources.

In further or alternative embodiments, other carbon materials, such as bamboo carbon, carbon black or the like can be employed in addition to or instead of carbon fiber. The carbon materials are dispersed in a powder base material, with a diameter of grains of the base material being in the range from 0.5˜100 μm. The mixture of base material and carbon materials is then mixed into a polymer material to form a frame such as the frame 160. Alternatively, the mixture of base material and carbon materials is used to form a coating for covering surfaces of a main body of a frame such as the main body 361.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module, comprising:
a light source;
a frame for containing the light source therein, and the frame comprising absorbing material configured for absorbing electromagnetic radiation generated by the light source.

2. The backlight module as claimed in claim 1, wherein the frame is made of polymer material, and the absorbing material is carbon material mixed and dispersed in the polymer material.

3. The backlight module as claimed in claim 1, wherein the frame comprises a main body, and the absorbing material is a carbon material coating covering surfaces of the main body.

4. The backlight module as claimed in claim 1, wherein the absorbing material comprises carbon material.

5. The backlight module as claimed in claim 4, wherein the carbon material is selected from the group consisting of carbon fiber, bamboo carbon, and carbon black.

6. The backlight module as claimed in claim 4, wherein the carbon material is dispersed in a powder base material, with a diameter of grains of the base material is in the range from 0.5˜100 μm.

7. A liquid crystal display device, comprising:
a liquid crystal display (LCD) panel; and
a backlight module arranged for illuminating the LCD panel, the backlight module comprising:
a light source; and
a frame containing the light source therein, the frame comprising an absorbing material configured for absorbing electromagnetic radiation generated by the light source.

8. The liquid crystal display device as claimed in claim 7, wherein the frame is made of polymer material, and the absorbing material is carbon material mixed and dispersed in the polymer material.

9. The liquid crystal display device as claimed in claim 7, wherein the frame comprises a main body, and the absorbing material is a carbon material coating covering surfaces of the main body.

10. The liquid crystal display device as claimed in claim 7, wherein the absorbing material comprises carbon material.

11. The liquid crystal display device as claimed in claim 10, wherein the carbon material is selected from the group consisting of carbon fiber, bamboo carbon, and carbon black.

12. The liquid crystal display device as claimed in claim 10, wherein the carbon material is dispersed in a powder base material, with a diameter of grains of the base material is in the range of 0.5˜100 μm.

13. A backlight module, comprising:
a light source including a light guide plate;
a frame for supportably containing the light source therein, and the frame coated with an absorbing material for absorbing electromagnetic radiation generated by the light source.
